(19) United States
(12) Patent Application Publication
(10) Pub. No.: US 2008/0028216 A1
(43) Pub. Date: Jan. 31, 2008

(54) Information processing system, information processing apparatus, information processing method and computer readable medium

(75) Inventors: Masaki Kyojima, Tokyo (JP); Kazuo Saito, Tokyo (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 11/785,455

(22) Filed: Apr. 18, 2007

(30) Foreign Application Priority Data
Jul. 28, 2006 (JP) 2006-205476

(51) Int. Cl. H04L 9/00

(52) U.S. Cl. 713/168

(57) ABSTRACT

An information processing system is provided and includes first and second information processing apparatuses. The first information processing apparatuses includes a license issuing unit that issues a license permitting a utilization of information, and a registration requesting unit that gives a registration request to an information processing apparatus so as to register authentication information necessary for authenticating the license. The second information processing apparatus includes an information registering unit that registers the authentication information in response to the registration request from the first information processing apparatus, a request accepting unit that accepts an authentication request for authenticating the license, and an authenticating unit that authenticates the license based on the authentication information in response to the authentication request.

### CROSS-REFERENCE TO RELATED APPLICATION

This application is based on and claims priority under 35 USC §119 from Japanese Patent Application No. 2006-205476 filed Jul. 28, 2006.

### BACKGROUND

(i) Technical Field

The present invention relates to an information processing system, an information processing apparatus, an information processing method and a computer readable medium.

(ii) Related Art

In order to protect a copyright, an encoded content is caused to be available through a communication line. In order to utilize the encoded content, a license that permits a utilization of the content is required.

### SUMMARY

According to one aspect of the present invention, there is provided an information processing system comprising:

a first information processing apparatus comprising:
a license issuing unit that issues a license permitting a utilization of information, and
a registration requesting unit that gives a registration request to a second information processing apparatus so as to register authentication information necessary for authenticating the license; and

a second information processing apparatus comprising:
an information registering unit that registers the authentication information in response to the registration request from the first information processing apparatus,
a request accepting unit that accepts an authentication request for authenticating the license, and

an authenticating unit that authenticates the license based on the authentication information in response to the authentication request.

### BRIEF DESCRIPTION OF THE DRAWINGS

Embodiments of the present invention will be described in detail based on the following figures, wherein:

FIG. 1 is a block diagram showing a whole system according to an exemplary embodiment;

FIG. 2 is a block diagram showing a structure of the whole system including a network relationship among a user client, a license issuer and an approver (authentication apparatus);

FIG. 3 is a flowchart for explaining a summary of a processing to be executed by a user client, a license issuer and an approver (authentication apparatus);

FIG. 4 is a flowchart showing a processing to be executed in a license issuance;

FIG. 5 is a flowchart showing a processing to be executed in a content utilization;

FIG. 6 is a block diagram showing a hardware structure of a computer according to an exemplary embodiment; and

FIG. 7 is an explanatory diagram showing an embodiment in the related art.

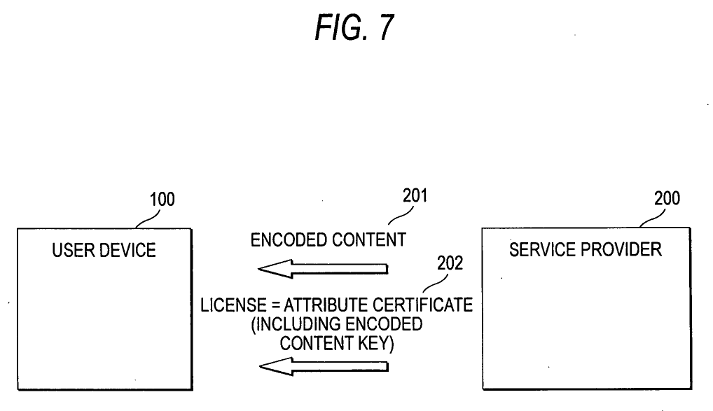

### DETAILED DESCRIPTION

Features according to exemplary embodiments will be described below.

(1) A service provider is divided into two mechanisms including a license issuer for carrying out an only issuance of a license and an approver (i.e., an authentication apparatus) for receiving an online approval request (i.e., an online authentication request) from a user and returning a result of the approval (i.e., authentication).

(2) In the case in which the license issuer issues a license which is to be subjected to the online approval, an approver for taking charge of the online approval is selected and a license requiring the online approval for the approver is issued to the user, and the online approval of the issued license is entrusted to the approver.

(3) A client program in a user environment communicates with an approver specified by the license to execute the online approval when the license is to be approved (authenticated).

Description will be given to a summary of the embodiment.

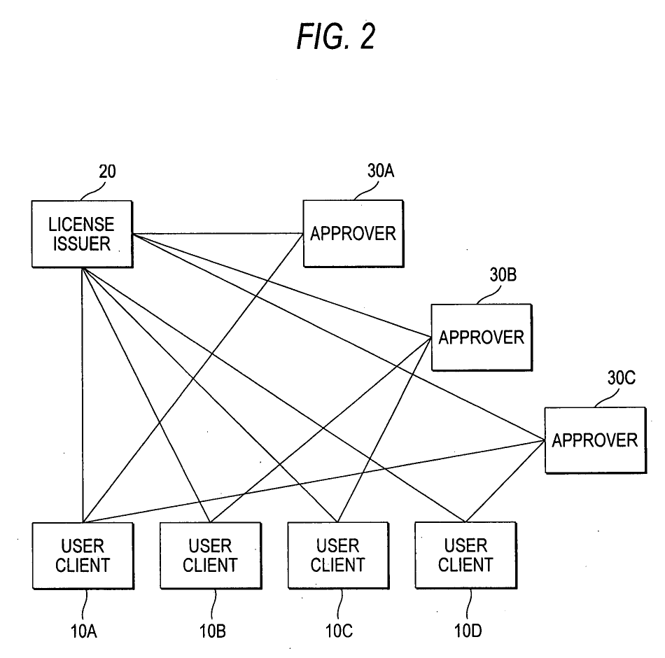

Referring to FIG. 2, description will be given to a structure of a whole system including a network relationship among a user client 10, a license issuer 20 and an approver 30.

As shown in FIG. 2, a plurality of user clients 10 (10A, 10B, 10C and 10D) is connected to the license issuer 20 through communication lines, respectively. A plurality of approvers 30 is provided. The approvers 30 are also connected to the license issuer 20 through communication lines, respectively. Moreover, the user client 10 is connected to at least one approver 30 through a communication line. For example, the user client 10A is connected to approvers 30A and 30C, the user client 10B is connected to an approver 30B, the user client 10C is connected to the approver 30B, and the user client 10D is connected to the approver 30C.

In the case in which the user client 10A wants to obtain a license of a content, it gives a request for issuing the license to the license issuer 20. The license issuer 20 issues the license to the user client 10A, and furthermore, registers necessary information for a license approval in the approvers 30A and 30C. When the user client 10A requires the license approval, a request for the online approval is given to the approver 30A or 30C.

A plurality of license issuers 20 may be provided and one user client 10 and one approver 30 may be provided.

### “Structure of License Issuer 20 and Approver 30”

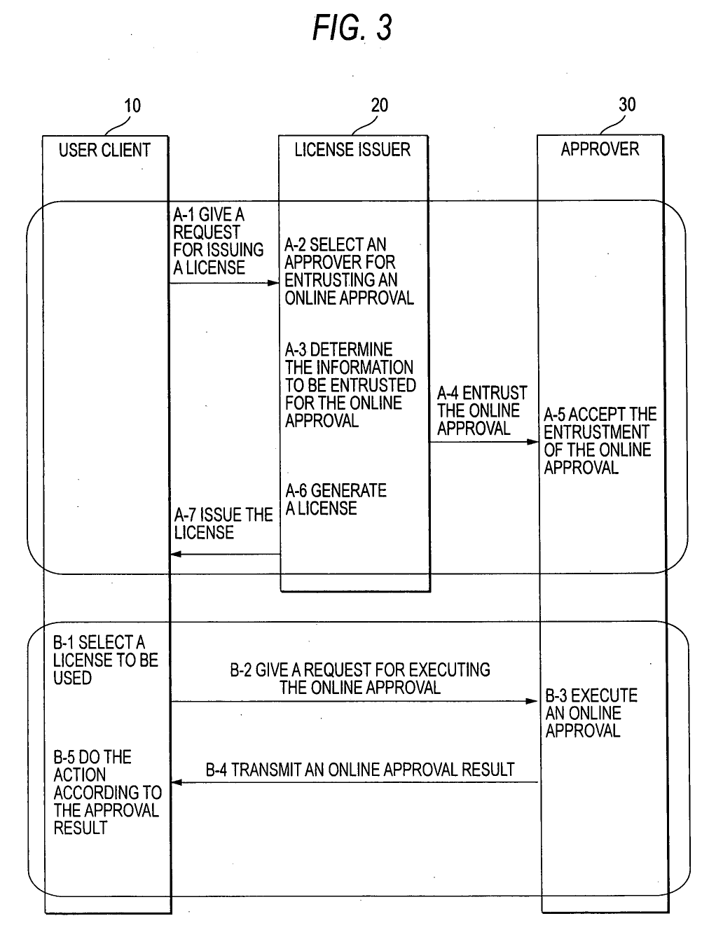

As shown in FIG. 3, a license for permitting a utilization of a content or an application for the user client 10 is issued by the license issuer 20. In the case in which the license that needs an online approval when it is verified is issued, the license issuer 20 entrusts the online approval to the approver 30. The “entrust” implies that the license issuer 20 gives the approver 30 a request for registering necessary information for the online approval in a database in such a manner that the approver 30 can carry out the online approval over the license issued by the license issuer 20. Moreover, the license issuer 20 is dedicated to a license issuance and does not approve the license issued by itself. The approver 30 is also dedicated to the approval and does not issue the license.

### “Issuance of License”

A processing from Steps A-1 to A-7 is a flow for the issuance of the license. A processing from Steps B-1 to B-5 is a flow for the online approval of the license.

At the Step A-1, the user client 10 gives the license issuer 20 a request for issuing a license.

At the Step A-2, the license issuer 20 selects the approver 30 for entrusting an online approval to the license in response to the request in the Step A-1. Although one approver 30 is provided in FIG. 3, it is assumed that a plurality of approvers 30 is provided as shown in FIG. 2. Moreover, a plurality of approvers 30 may be selected.

At the Step A-3, information to be entrusted for the online approval is determined. Detailed description will be given below.

At the Step A-4, the license issuer 20 entrusts the online approval to the approver 30 selected at the Step A-2.

At the Step A-5, the approver 30 accepts the entrustment of the online approval from the license issuer 20.

At the Step A-6, a license corresponding to the Step A-1 is generated.

At the Step A-7, the license generated at the Step A-6 is issued for the user client 10.

### “Online Approval”

At the Step B-1, the user client 10 selects a license when a content or an application is to be utilized, for example.

If the license selected at the Step B-1 needs a online Approval, at the Step B-2, the user client 10 gives a request for executing the online approval to the approver 30 to which the online approval for the license is entrusted.

At the Step B-3, the approver 30 executes the online approval in response to the request in the Step B-2.

At the Step B-4, the approver 30 transmits the result of the online approval in the Step B-3 to the user client 10.

At the Step B-5, the user client 10 receives the result of the online approval from the approver 30 and does the action according the result. In other words, in the case in which the online approval is successful, it is possible to utilize the content.

The order for the step sequence of “Step A-3→Step A-4→Step A-5” in the license issuing process of FIG. 3 and the step sequence of “Step A-6→Step A-7” may be reversed. In other words, it is also possible to carry out the step sequence of “Step A-3→Step A-4→Step A-5” after the step sequence of “Step A-6→Step A-7”.

### “Send Policy in Entrustment of Online Approval”

When the online approval is to be entrusted from the license issuer 20 to the approver 30 at the step sequence of “Step A-3→Step A-4”, the license issuer 20 sends an approval policy and the approver 30 registers the policy. The approval policy is as follows:

(1) The number of times of the execution of the online approval (an upper limit number of times that the online approval is executed);

(2) A period for which the online approval is executed (a period for which the online approval is permitted);

(3) A function permitted by the online approval (for example, “read” is permitted and “print” is not permitted); and

(4) A side effect produced on the user client 10 in the online approval. More specifically, there are the following two side effects:

A change in a policy described on a license; and

An invalidation of the policy.

“Select Approver 30 in Entrustment of Online Approval”

When the entrustment of the online approval is to be carried out from the license issuer 20 to the approver 30 at the Step A-2, it is possible to select the approver 30 depending on various conditions in the following manner, for example.

(1) The approver 30 to be entrusted may be selected depending on the processing load of the candidate approvers, i.e. the approvers 30 which has the lowest load may be selected.

(2) The approver 30 to be entrusted may be selected depending on an attribute of a user who use a content through a license. For example, the selected approver may be the one that is managed in a division to which the user belongs.

(3) The approver 30 to be entrusted may be selected depending on a type and an attribute of the content which can be utilized by the license. For example, the selected approver may be the one that is managed by an organization by which the content is provided.

(4) The approver 30 to be entrusted may be selected depending on a network environment of a device (the user client 10 such as a PC) on which is the license is used. For example, on issuance of a license for a device provided in intranet, the approver 30 in the same intranet may be selected. And on issuance of a license for a device provided on an outside of the intranet, the approver 30 on the Internet may be selected. For another example, the approver 30 that is the closest to the device on a network basis may be selected.

### “Entrustment of Online Approval to Approvers 30”

Moreover, the online approval for a single license may be entrusted to plural approvers 30.

In that case, the user client 10 may select the approver 30 in an execution of the online approval. In the case in which the online approval of the license issued from the license issuer 20 is entrusted to a plurality of approvers 30, the approver 30 for executing the online approval is selected on various conditions when the content is to be utilized. For example, a selecting method is as follows.

(1) The approver 30 for executing the online approval may be selected depending on the processing load of the candidate approvers, i.e. the approver 30 which has the lowest load may be selected.

(2) The approver 30 for executing the online approval may be selected depending on a network environment of a device (the user client 10 such as a PC) utilizing a content. For example, in the case in which the device is provided in intranet, the approver 30 in the same intranet may be selected. In the case in which the device is provided on an outside of the intranet, the approver 30 on Internet may be selected. For another example, the closest approver 30 to the device on the network basis may be selected.

### First Embodiment

Various preferred embodiments will be described below with reference to the drawings.

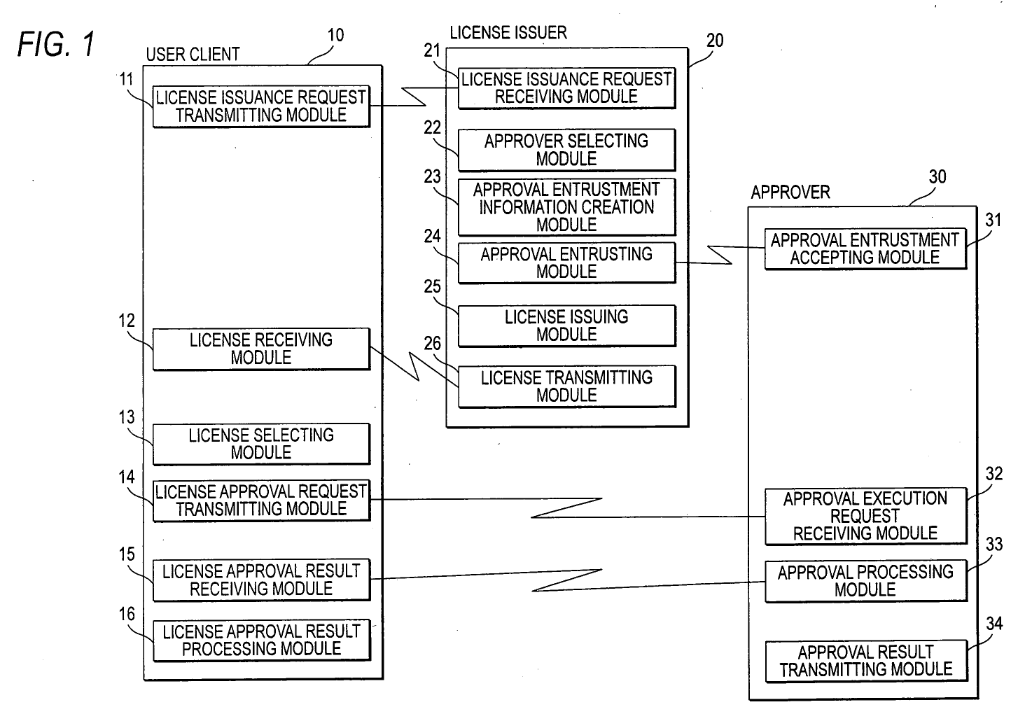

FIG. 1 is a diagram showing a conceptual module structure according to an embodiment.

The word “module” generally indicates a component such as a logically separable software or hardware. Accordingly, the module according to the embodiment also indicates a module in a hardware structure in addition to a module in a program. In the embodiment, therefore, there will also be described a program, an apparatus, a system and a method. Moreover, the module has an almost one-to-one correspondence to a function. In implementation, however, one module may be constituted by one program or a plurality of modules may be constituted by one program. To the contrary, one module may be constituted by a plurality of programs. Moreover, a plurality of modules may be executed by one computer or one module may be executed by a plurality of computers in a distributing or parallel environment. Furthermore, “connection” will include a logical connection in addition to a physical connection.

In addition, the “system” is constituted by connecting a plurality of computers, hardwares and apparatuses through a network, and furthermore, is implemented by one computer in some cases.

Description will be mainly given, as an example, to a license related to a utilization control of a content or an application as a license that controls a utilization of information (that is, a license).

In the embodiment, as shown in FIG. 1, there are wholly provided a user client 10, a license issuer 20 and an approver 30. The user client 10 includes a license issuance request transmitting module 11, a license receiving module 12, a license selecting module 13, a license approval request transmitting module 14, a license approval result receiving module 15, and a license approval result processing module 16, the license issuer 20 includes a license issuance request receiving module 21, an approver selecting module 22, an approval entrustment information creation module 23, an approval entrusting module 24, a license issuing module 25, and a license transmitting module 26, and the approver 30 includes an approval entrustment accepting module 31, an approval execution request receiving module 32, an approval processing module 33, and an approval result transmitting module 34.

The license issuance request transmitting module 11 is connected to the license issuance request receiving module 21 of the license issuer 20 through a communication line and transmits, to the license issuer 20, a request for issuing a license necessary for utilizing a content or an application.

The license receiving module 12 is connected to the license transmitting module 26 of the license issuer 20 through a communication line and receives the license transmitted from the license transmitting module 26 of the license issuer 20.

The license selecting module 13 selects a necessary license for utilizing the content or the application. In the case in which a plurality of approvers 30 is provided, any of the approvers 30 can be selected in the selection or may be selected depending on the selection of the license. The details will be described in a third embodiment.

The license approval request transmitting module 14 is connected to the approval execution request receiving module 32 of the approver 30 through a communication line and transmits, to the approver 30, a license approval request in an online. In the case in which a plurality of approvers 30 is provided, the request is transmitted to the approver 30 selected by the license selecting module 13.

The license approval result receiving module 15 is connected to the approval result transmitting module 34 of the approver 30 through a communication line and receives the approval result of the license through the approver 30.

The license approval result processing module 16 utilizes the content or the application depending on the approval result of the license received by the license approval result receiving module 15. As a matter of course, in the case in which the approval result of the license is “disable”, the content or the application cannot be utilized. In the case in which the license restricts the utilization, moreover, the utilization in accordance with the restriction is carried out.

The license issuance request receiving module 21 is connected to the license issuance request transmitting module 11 of the user client 10 through a communication line and receives a license issuance request transmitted from the license issuance request transmitting module 11 of the user client 10.

The approver selecting module 22 selects the approver 30 which is suitable for an issued license (or a license to be issued). The details will be described in a second embodiment.

The approval entrustment information creation module 23 determines necessary information for approving the license issued by the license issuing module 25.

The approval entrusting module 24 is connected to the approval entrustment accepting module 31 of the approver 30 through a communication line. The approval entrusting module 24 entrusts necessary information for approving a license determined by the approval entrustment information creation module 23 to the approver 30. The approval entrusting module 24 may give the entrustment to a plurality of approvers 30. In particular, the entrustment may be given to the approvers 30 provided on an inside and an outside of the firewall.

The “firewall” is a system for implementing a function for monitoring data flowing through a boundary with the outside and detecting and blocking a wrong access in order to prevent a third party from entering a computer network from the outside to carry out a stolen glance, a falsification and a destruction of data and programs. An inside of a range of the network monitored by a system for preventing the wrong invasion is referred to as “an inside of the firewall” and an outside of the range is referred to as an “outside of the firewall”.

The license issuing module 25 issues the license if the issuance of the license is proper corresponding to the request for issuing the license which is received by the license issuance request receiving module 21.

The license transmitting module 26 is connected to the license receiving module 12 of the user client 10 through a communication line and transmits the license issued by the license issuing module 25 to the user client 10 to be an issuing request source for the license.

The approval entrustment accepting module 31 is connected to the approval entrusting module 24 of the license issuer 20 through a communication line and registers necessary information for approving the license corresponding to the entrustment transmitted by the approval entrusting module 24 of the license issuer 20.

The approval execution request receiving module 32 is connected to the license approval request transmitting module 14 of the user client 10 through a communication line and accepts a request for the license approval through the license approval request transmitting module 14 of the user client 10.

The approval processing module 33 approves the license by using information corresponding to the license registered by the approval entrustment accepting module 31 in response to the approval request accepted by the approval execution request receiving module 32.

The approval result transmitting module 34 is connected to the license approval result receiving module 15 of the user client 10 through a communication line and transmits the result of the approval of the license which is carried out by the approval processing module 33 to the user client 10 to be a request source for the license approval.

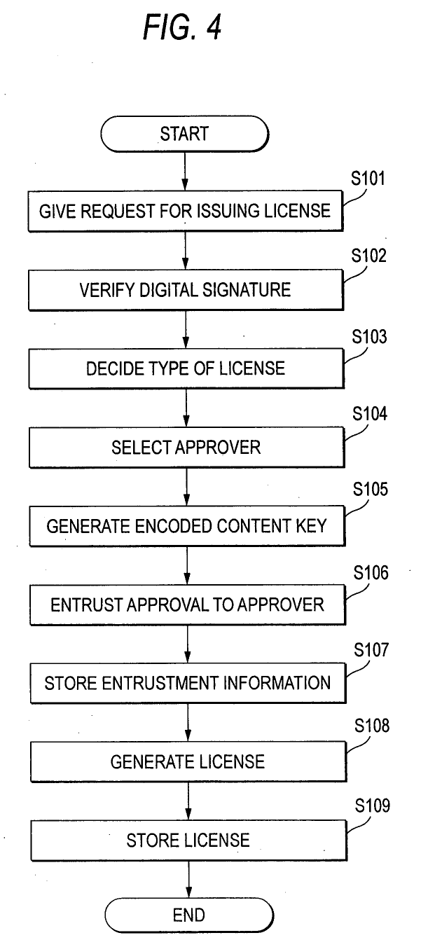

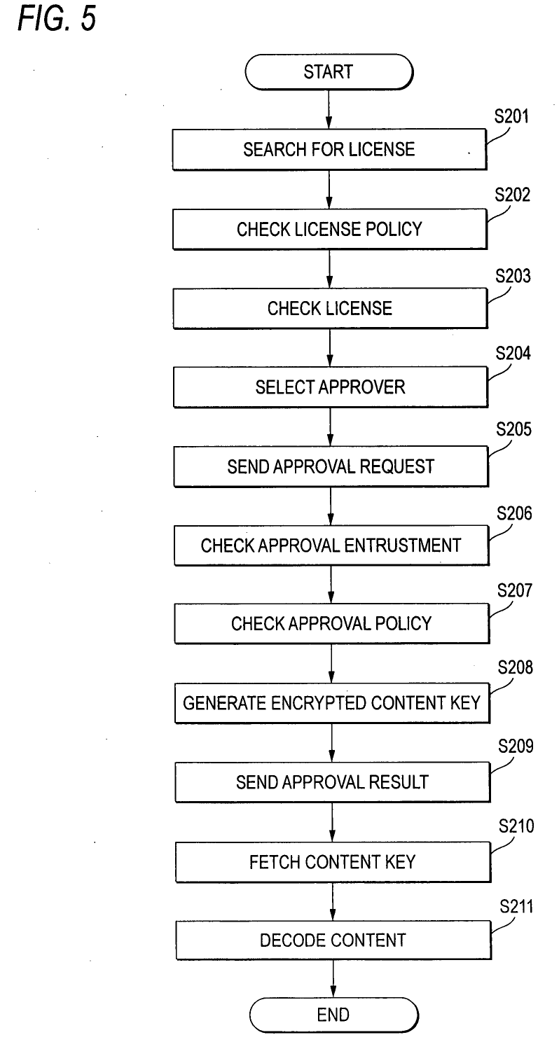

Next, functions and actions (operations) will be described with reference to FIGS. 4 and 5.

### “Setting”

First of all, the following setting is carried out before a processing of a license issuance (FIG. 4) is performed.

(1) The user client 10 (U) has a public keypair (a public key P_{U} and a private key S_{U}). An identifier I_{U} is assigned to the user client 10 (U).

(2) The license issuer 20 (LI) has a public key pair (a public key P_{LI}, a private key S_{LI}).

(3) Plural approvers 30 (A1, A2, . . . , An) are present. An identifier I_{Ai} is assigned to the approver 30 (Ai). Moreover, the approver 30 (Ai) has a public key pair (a public key P_{Ai}, a private key S_{Ai}).

(4) A content C is encoded by a content key K_{C}. An identifier I_{C} is assigned to the content. The content C may be a software application.

(5) The license issuer 20 (LI) holds the identifier I_{C} of the content and the content key K_{C}. (The license issuer 20 can issue only a license of a content holding a content identifier and a content key).

(6) An identifier I_{L} is assigned to a license L.

### “Issuance of License”

A processing in an issuance of a license will be described with reference to FIG. 4.

Step S101 is a processing to be executed in the user client 10.

In the case in which a user having the user client 10 (U) uses the content C, a request for a license to C is first given to the license issuer 20 (L).

In this case, the license issuing request is generated in the user client 10 and is sent to the license issuer 20. The license issuing request includes at least the following information:

(1) Request date and time;

(2) The identifier I_{U} of the user client 10 possessed by a requester;

(3) The identifier I_{C} of the content C requiring a license; and

(4) A digital signature of the user client 10 (U) for a whole license issuing request.

Step S102 is a processing to be executed in the license issuer 20.

The license issuer 20 (L) receiving the license issuing request verifies the digital signature of the license issuing request.

Step S103 is a processing to be executed in the license issuer 20.

A type of license is decided. This embodiment has two types of license. One type is “on-line license”. The license of this type is to be approved with a license approval by an approver. Another type is “off-line license”. The license of this type is to be approved without a license approval by an approver. A processing of issuing the on-line license will be mainly described below.

Step S104 is a processing to be executed in the license issuer 20.

In the case in which the on-line license is issued, the approver 30 for entrusting the online approval is selected. It is possible to select plural approvers 30.

Step S105 is a processing to be executed in the license issuer 20.

The content key K_{C} is encrypted by the public key of the approver 30 and an encrypted content key is generated. In the case in which plural approvers 30 are selected, the encrypted content key is generated for every approver 30 thus selected.

For example, in the case in which the approvers 30 (A1, A2, . . . , Ak) are selected, the following encrypted content keys E_{A1,A}, E_{A2,C}, . . . , E_{Ak,C} can be obtained.

E_{Ai,C}=PEnc(P_{Ai}, K_{C})

### PEnc(x, y) is a result obtained by encrypting y by the public key x.

Step S106 is a processing to be executed in the license issuer 20.

The entrustment of the online approval is executed for the approver 30.

In this case, a request for entrusting the online approval is sent from the license issuer 20 to the approver 30. The request for entrusting the online approval includes at least the following information:

(1) Request date and time;

(2) Identifier of the license I_{L};

(3) Identifier of the user client 10 to be issuing destination of license I_{U};

(4) Policy of online approval;
(4-1) Number of times that the online approval is executed,
(4-2) Period for which the online approval is carried out,
(4-3) Function capable of being permitted by the online approval, and
(4-4) Others and

(5) Digital signature of the license issuer 20 (L) for the whole online approval entrusting request.

Step S107 is a processing to be executed in the approver 30.

The approver 30 receiving the entrustment of the online approval verifies the digital signature of the online approval entrusting request, and stores the contents of the entrustment if there is no problem.

Step S108 is a processing to be executed in the license issuer 20.

A license is generated and sent to the user client 10 (U). The license includes at least the following information:

(1) Issuance date and time;

(2) Identifier of license I_{L};

(3) Identifier of the content for which the license is made I_{C};

(4) List of encrypted content key (list of the following information);
(4-1) Identifier of the approver 30 I_{Ai},
(4-2) URL of the approver 30 URL_{Ai}, and
(4-3) Encrypted content key E_{Ai,C},

(5) License policy;
(5-1) Number of times that the content can be utilized,
(5-2) Period for which the content can be utilized,
(5-3) Function capable of being executed for the content (indicating “read”, “print” and “edit”), and
(5-4) Others and

(6) Digital signature of the license issuer 20 (L) for the whole license.

Step S109 is a processing to be executed in the user client 10.

The user client 10 receiving the license sent from the license issuer 20 verifies the digital signature given to the license, and stores the license if there is no problem.

### “Utilization of Content (including Online Approval)”

With reference to FIG. 5, description will be given to a processing in the utilization of a content.

Step S201 is a processing to be executed in the user client 10.

In the case in which the content C is utilized, the user client 10 searches for a license for utilizing the content C.

Step S202 is a processing to be executed in the user client 10.

If the license is found, it is checked whether the contents of the license policy are satisfied or not. If they are not satisfied, the utilization of the content C is denied.

Step S203 is a processing to be executed in the user client 10.

It is checked whether the license is on-line license or off-line license. A processing of using the on-line license will be mainly described below.

Step S204 is a processing to be executed in the user client 10.

In the case in which the license is on-line license, the approver 30 to be a partner of the online approval is selected. The approver 30 which can be selected is included in “a list of encrypted content keys” in the license. A selecting method will be described in detail in the following third embodiment.

Step S205 is a processing to be executed in the user client 10.

An online approval request is created and sent to the URL of the approver 30 which is selected.

The online approval request includes at least the following information (in case of the license Land the approver 30 (Ai)):

(1) Serial number of request;

(2) Request date and time;

(3) Identifier of license I_{L};

(4) Encryopted content key E_{Ai,C}; and

(5) Digital signature of the user client 10 for whole online approval request.

Step S206 is a processing to be executed in the approver 30.

The approver 30 receiving the online approval request verifies the digital signature given to the online approval request, and checks whether or not the online approval is already entrusted for the license to which the online approval request is given if there is no problem. If the online approval is not entrusted, an error of the online approval is returned to the user client 10.

Step S207 is a processing to be executed in the approver 30.

It is checked whether the contents of the “policy of online approval” for the entrustment of the online approval for the license to which the online approval request is given are satisfied or not. If they are not satisfied, the error of the online approval is returned to the user client 10.

Step S208 is a processing to be executed in the approver 30.

The encrypted content key E_{Ai,C} is decrypted by the private key S_{Ai} possessed by the approver 30 (Ai) and the content key K_{C} is fetched and encrypted with the public key P_{U} of the user client 10 so that an encrypted content key E_{U,C} is created.

Step S209 is a processing to be executed in the approver 30.

The approver 30 creates an online approval result and sends it to the user client 10.

The online approval result includes at least the following information:

(1) Serial number which is included in the approval request;

(2) Approval date and time;

(3) Encrypted content key E_{U,C}; and

(4) Digital signature of the approver 30 for whole online approval result.

Step S210 is a processing to be executed in the user client 10.

The user client 10 receiving the online approval result verifies the digital signature given to the online approval result, and decrypts the encrypted content key E_{U,C} with the private key S_{U} possessed by the user client 10 and fetches the content key K_{C} if there is no problem.

Step S211 is a processing to be executed in the user client 10.

The content is decrypted with the content key K_{C} to be utilized by the user.

### Second Embodiment

A second embodiment will be described.

In the embodiment, in addition to the first embodiment, there is provided a mechanism for selecting the approver 30 to which the license issuer 20 entrusts the online approval depending on various conditions.

The same portions as those in the first embodiment have the same reference numerals and repetitive description will be omitted.

### Second Embodiment (1)”

In addition to the first embodiment, the license issuer 20 entrusts the online approval to the approver 30 having the lowest load. The specific way of this entrustment is as follows.

(1) The license issuer 20 has a function for making an inquiry of the load of the approver 30 in addition to that described in the first embodiment.

(2) In addition, in the license issuing process according to the first embodiment, the inquiry of the load is made for the approver 30 group to be a candidate at the Step S104. As a result, the approver 30 having the lowest load is selected.

### Second Embodiment (2)”

In addition to the first embodiment, the license issuer 20 selects the approver 30 for entrusting an online approval depending on an attributive of a user capable of utilizing a content. The specific way of this added function is as follows.

(1-1) The approver 30 is present for each division, and the license issuer 20 has a table of the relation between each approver 30 and the division that manages the approver 30.

In addition, the following operation is carried out in the license issuing process according to the first embodiment.

(1-2) At the Step S101, the user client 10 describes a division name to which a user utilizing the user client 10 belongs on a license issuing request to be sent to the license issuer 20.

(1-3) At the Step S104, the license issuer 20 searches for the corresponding approver 30 from the division name described on the license issuing request, and the approver 30 is selected as an entrusting destination of the online approval.

Moreover, the following operation may be carried out.

(2-1) The approver 30 is present for each division, and the license issuer 20 has a table of the relation between each approver 30 and the division that manages the approver 30.

(2-2) There is a DB (a user information DB) storing corresponding information of a division and an identifier of a user belonging to the same division, and the license issuer 20 can make an inquiry to the same DB.

In addition, the following operation is carried out in the license issuing process according to the first embodiment.

(2-3) At the Step S101, the user client 10 describes the identifier of the user utilizing the user client 10 on the license issuing request to be sent to the license issuer 20.

(2-4) At the Step S104, the license issuer 20 fetches the identifier of the user described on the license issuing request and makes an inquiry to the user information DB, and acquires a division name to which the user of the identifier belongs. The approver 30 corresponding to the same division is searched and selected as an entrusting destination of the online approval.

### Second Embodiment (3)

In addition to the first embodiment, the license issuer 20 selects the approver 30 for entrusting an online approval depending on a type and an attributive of a content that can be utilized by a license. The specific way of this added function is as follows.

(3-1) The approver 30 is present for each organization or corporation which creates the content, and the license issuer 20 has a table of the relation between each approver 30 and the identifier of the organization or corporation that manages the approver 30.

In addition, the following operation is carried out in the license issuing process according to the first embodiment.

(3-2) At the Step S101, the user client 10 describes the identifier of the organization or corporation creating a content to which a request for issuing a license is given on the license issuing request to be sent to the license issuer 20.

(3-3) At the Step S104, the license issuer 20 searches for the corresponding approver 30 from the identifier of the organization or corporation which is described on the license issuing request and the approver 30 is selected as an entrusting destination for the online approval.

### Second Embodiment (4)

In addition to the first embodiment, the license issuer 20 selects the approver 30 for entrusting an online approval depending on a network environment of a PC on which the client 10 works. The specific way is as follows.

(4-1) The license issuer 20 holds information of a plurality of approvers 30 as an entrusting destination of the online approval.

(4-2) There is provided a system (a hop count system) for calculating the number of hops through the shortest path between the approver 30 and the user client 10, and the license issuer 20 can make an inquiry to the hop count system.

In addition, the following operation is carried out in the license issuing process according to the first embodiment.

(4-3) At the Step S101, the user client 10 describes an IP address of a PC utilizing a content on a license issuing request to be sent to the license issuer 20.

(4-4) At the Step S104, the license issuer 20 fetches the IP address of the PC utilizing the content described on the license issuing request and utilizes the hop count system to acquire the number of hops from the same address to the individual approver 30, thereby selecting the approver 30 having the smallest number of hops as the entrusting destination of the online approval.

### Third Embodiment

A third embodiment will be described.

In the embodiment, in addition to the first embodiment, there is provided a mechanism for selecting the approver 30 to which the user client 10 gives a request for the online approval depending on various conditions in the case in which the approvers 30 are described on a license.

The same portions as those in the first embodiment have the same reference numerals and repetitive description will be omitted.

### Third Embodiment (1)

In addition to the first embodiment, the user client 10 sends a request for the online approval to the approver 30 having the lowest load. The specific way is as follows.

(1-1) In addition to the description of the first embodiment, the user client 10 has a function for making an inquiry to the load of the approver 30.

In addition, the following operation is carried out in the content utilizing process according to the first embodiment.

(1-2) At the Step S204, the inquiry of the load is made for the approver 30 group to be a candidate. As a result, the approver 30 having the lowest load is selected.

### Third Embodiment (2)

In addition to the first embodiment, the user client 10 selects the approver 30 to which a request for the online approval is given depending on its own network environment. The specific way is as follows.

(2-1) There is provided a system (a hop count system) for calculating the number of the shortest hops between the approver 30 and the user client 10, and the user client 10 can make an inquiry to the hop count system.

In addition, the following operation is carried out in the content utilizing process according to the first embodiment.

(2-2) At the Step S204, the number of hops sent from the PC on which the user client 10 works is acquired for the approver 30 group described on the license by utilizing the hop count system, and the approver 30 having the smallest number of hops is selected as a request destination of the online approval.

### “Hardware Structure”

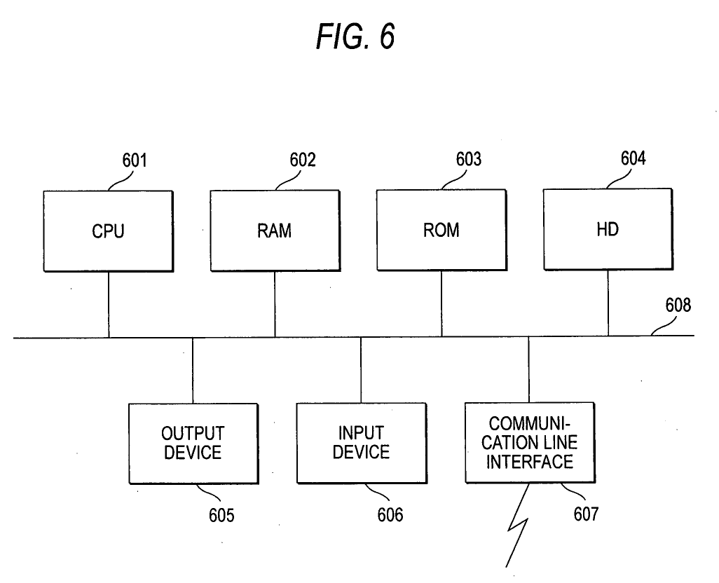

A hardware structure of a computer for executing a program according to the embodiment is a general computer as shown in FIG. 6, and more specifically, the user client 10 works on a personal computer, and the license issuer 20 and the approver 30 work on server computers. The computer comprises a CPU 601 for executing a program, a RAM 602 for storing the program and data, a ROM 603 for storing a program to start the computer, an HD 604 to be an auxiliary storage device, an input device 606 for inputting data, for example, a keyboard or a mouse, an output device 605 such as a CRT or a liquid crystal display, a communication line interface 607 for carrying out a connection to a communication network, and a bus 608 for connecting them and transferring data. A plurality of computers may be connected to each other through a network.

The hardware structure shown in FIG. 6 is only illustrative and the embodiment is not restricted to the structure shown in FIG. 6 but it is preferable to employ a structure that can execute the module described in the embodiment. For example, a part of the modules may be constituted by a single purpose hardware (for example, an ASIC) In particular, moreover, the user client 10 may be incorporated into a cell phone, a game machine, a car navigation machine, information household appliances, a copying machine, a fax, a scanner, a printer, and a complex machine (which is also referred to as a multifunctional copying machine having functions of a scanner, a printer, a copying machine and a fax) in addition to the personal computer.

The program described above can also be stored in a recording medium, and can also be provided by a communicating unit. In that case, the program can also be thought as the invention of “a computer readable recording medium recording a program”, for example.

The “computer readable recording medium recording a program” implies a recording medium that records a program to be used for an installation of a program, an execution and a distribution of a program.

For example, the recording medium includes “a DVD-R, a DVD-RW and a DVD-RAM” to be standards formulated in a DVD forum which are digital versatile disks (DVDs), “a DVD+R and a DVD+RW” to be standards formulated in DVD+RW, a read only memory (CD-ROM), a CD recordable (CD-R) and a CD rewritable (CD-RW) to be compact disks (CDs), a magneto-optical disk (MO), a flexible disk (FD), a magnetic tape, a hard disk, a read only memory (ROM), an electrically erasable programmable read only memory (EEPROM), a flash memory and a random access memory (RAM).

The program or a part thereof can be recorded in the recording medium and can be thus retained and distributed. Moreover, they can be transmitted by using a cable network to be utilized in a transmitting medium such as a local area network (LAN), a metropolitan area network (MAN), a wide area network (WAN), internet, intranet or extranet through a communication or a radio communication network, and furthermore, their combination, and can also be delivered with a carrier.

In addition, the program may be a part of the other programs or may be recorded in the recording medium together with separate programs.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a first information processing apparatus comprising:
a license issuing unit that issues a license permitting a utilization of information, and
a registration requesting unit that gives a registration request to an information processing apparatus so as to register authentication information necessary for authenticating the license; and
a second information processing apparatus comprising:
an information registering unit that registers the authentication information in response to the registration request from the first information processing apparatus,
a request accepting unit that accepts an authentication request for authenticating the license, and
an authenticating unit that authenticates the license based on the authentication information in response to the authentication request.

2. The information processing system according to claim 1, further comprising a third information processing apparatus comprising:
a license receiving unit that receives a license, and
a authentication requesting unit that gives an authentication request for authenticating the license to an information processing apparatus specified by the license.

3. The information processing system according to claim 1, wherein the registration requesting unit gives the registration request to the second information processing apparatus outside a firewall and the second information processing apparatus inside the firewall.

4. The information processing system according to claim 1, wherein the first information processing apparatus further comprises a selecting unit that selects one of the second information processing apparatuses that the registration request is given to from a plurality of second information processing apparatuses.

5. The information processing system according to claim 2, wherein the third information processing apparatus further comprises a selecting unit that selects one of the second information processing apparatuses that the authentication request is given to from a plurality of second information processing apparatuses.

6. An information processing apparatus comprising:
a license issuing unit that issues a license permitting a utilization of information, and
a registration requesting unit that gives a registration request to an authentication apparatus so as to register authentication information necessary for authenticating the license.

7. The information processing apparatus according to claim 6, wherein the registration requesting unit gives the registration request to the authentication apparatus outside a firewall and the authentication apparatus inside the firewall.

8. An information processing apparatus comprising:
an information registering unit that registers an authentication information necessary for authenticating a license permitting a utilization of information,
a request accepting unit that accepts an authentication request for authenticating the license, and
an authenticating unit that authenticates the license based on the authentication information in response to the authentication request.

9. An information processing apparatus comprising:
a license receiving unit that receives a license, and
a authentication requesting unit that gives an authentication request for authenticating the license to an authentication apparatus specified by the license.

10. A method for processing information, comprising:
issuing a license permitting a utilization of information; and
transmitting a registration request to an authentication apparatus so as to register an authentication information necessary for authenticating the license.

11. The method according to claim 10, wherein the registration request is transmitted to the authentication apparatus outside a firewall and the authentication apparatus inside the firewall.

12. A method for processing information, comprising:
registering an authentication information necessary for authenticating a license permitting a utilization of information,
accepting an authentication request for authenticating the license, and
authenticating the license based on the authentication information in response to the authentication request.

13. A method for processing information, comprising:
receiving a license, and
requesting to authenticate the license to an authentication apparatus specified by the license.

14. A computer readable medium storing a program causing a computer to execute a process for processing information, the process comprising:
issuing a license permitting a utilization of information; and
transmitting a registration request to an authentication apparatus so as to register an authentication information necessary for authenticating the license.

15. A computer readable medium storing a program causing a computer to execute a process for processing information, the process comprising:
registering an authentication information necessary for authenticating a license permitting a utilization of information,
accepting an authentication request for authenticating the license, and
authenticating the license based on the authentication
